(19) United States
(12) Patent Application Publication
(10) Pub. No.: US 2025/0247572 A1
(43) Pub. Date: Jul. 31, 2025

(54) Optimized management of manifest files for telecommunications clients receiving adaptive contents over http (HAS)

(71) Applicant: ORANGE, ISSY-LES-MOULINEAUX (FR)

(72) Inventors: Hervé Marchand, CHATILLON CEDEX (FR); Olivier Gaste, CHATILLON CEDEX (FR)

(21) Appl. No.: 19/024,306

(22) Filed: Jan. 16, 2025

(30) Foreign Application Priority Data
Jan. 25, 2024 (FR) 2400736

(51) Int. Cl. H04N 21/239; H04N 21/2187; H04N 21/262; H04N 21/437; H04N 21/845

(52) U.S. Cl. CPC H04N 21/2393; H04N 21/2187; H04N 21/26241; H04N 21/437; H04N 21/8456

(57) ABSTRACT

A method for managing access by a client to content available on at least one server through a telecommunications network, the content being temporally segmented into a sequence of data chunks. The method includes a transmission by the server of a file associating time segments with data chunk identifiers, as well as an action selected from a generation by the client within the file of at least one chunk identifier associated with a time segment and a transmission of a request towards the server to receive the file again.

### CROSS REFERENCE TO RELATED APPLICATION

This Application claims priority to and the benefit of French Patent Application No. FR 2400736, filed Jan. 25, 2024, the content of which is incorporated herein by reference in its entirety.

### TECHNICAL FIELD

The present invention relates to the distribution of contents, in particular audio-visual contents, through telecommunications networks towards end clients with a view to their production for users. It more particularly concerns the streaming of contents temporally segmented into sequences of data chunks, possibly into several resolutions. It applies in particular to streaming based on technologies such as HAS (Http Adaptive Streaming).

### BACKGROUND

In this type of technology, clients must retrieve files containing identifiers of the different data chunks constituting the content they wish to access. These identifiers contain the data allowing the client to be able to retrieve, individually, each data chunk, possibly in the desired resolution.

When the content is in production, for example because it is a live streaming that is not finished at the time the user accesses it, the client must periodically retrieve this file in order to obtain the identifiers of the new content chunks produced.

When a time-shifted playback function is used, the client must be able to access data chunks corresponding to temporal segments in the past. Also, a long period of time must be represented, in the file retrieved by the client, corresponding to a very large number of data chunks. Even if the file only contains identifiers of the data chunks, that is to say the information allowing the client to retrieve them, the size of the file can be considerable.

For example, if it is desired to allow the users to go back 4 hours in the past in time-shifted playback, and if the data chunks correspond to temporal segments of 2 seconds, the file must contain 7,200 identifiers per proposed resolution. Given the size of each identifier, a file of about 200 KB is obtained.

Retrieving this file regularly therefore generates congestion of the bandwidth between the content server and the client, and consequently, of the telecommunications network. It should be noted that, in some commercially deployed systems, the file is retrieved at a pace corresponding to the production (and consumption) of the data chunks, i.e. once every two seconds, which therefore generates a data stream of about 6MB/minute for each client. Furthermore, each request for the file solicits the server and uses its resources, at the risk of degrading its performance.

There is therefore a need to improve the current proposals of the state of the art, in order to minimize the occupation of this bandwidth for clients using a time-shifted playback function of content available in sequence of data chunks.

### SUMMARY

For these purposes, according to a first aspect, the present invention can be implemented by a method for managing access by a client to content available on at least one server through a telecommunications network, said content being temporally segmented into a sequence of data chunks, said method comprising a transmission by said server of a file associating time segments with data chunk identifiers, as well as an action selected among a generation by said client within said file of at least one chunk identifier associated with a time segment and a transmission of a request towards said server to receive said file again.

Thus, in the case where the content is accessed in time-shifted playback, the file referencing the data chunks is no longer retrieved from the data server, since the client will not immediately use the new data chunks produced by the server. This avoids soliciting the resources of the server and of the telecommunications networks.

According to preferred embodiments, the invention comprises one or more of the following characteristics which may be used separately or in partial combination with each other or in total combination with each other:
said action is selected based on a comparison of an interval between a current time and a time segment which is being displayed with a threshold. This mechanism then allows self-adaptation by anticipating a future need to retrieve data chunks.
said generation is performed periodically, for a number of time segments corresponding to said period. Thus, the content of the file is kept synchronized with the production of the data chunks on the content server.
said period corresponds to a constant duration of said time segments. In this way, the synchronization is as accurate as possible.
the generated identifier is adapted to be determined by said client as not corresponding to said at least one server.
the method further includes, when an identifier generated by the client within said file during preparation of a request for a data chunk is detected, a transmission of a request towards said server to receive said file again. These embodiments make it possible not to modify the other software elements of the client, in particular the media content display application. Particularly, these will automatically detect that an identifier contained in the file must be subject to particular processing, in particular the retrieval of the manifest file from the content server.
a position indicator is displayed to position said time segment which is being displayed based on the chunk identifiers present within said file. Thus, the user can at any time know the lag between what he is watching and the content produced by the content server.
this content may be live-streamed content, but it can apply to other types of streaming of multimedia content.

Another aspect of the invention concerns a client comprising a processor configured to carry out the steps of receiving a file from a content server, associating time segments with data chunk identifiers, and of performing an action selected among a generation within said file of at least one chunk identifier associated with a time segment and a transmission of a request towards said server to receive said file again.

Another aspect of the invention concerns a computer program able to be implemented on a web server, the program comprising code instructions which, when executed by a processor, carries out the steps of the method as previously defined.

Another aspect of the invention concerns a non-transitory data medium storage on which at least one series of program code instructions has been stored for the execution of a method as previously defined.

Other characteristics and advantages of the invention will become apparent from reading the following description of one preferred embodiment of the invention, given by way of example and with reference to the appended drawings.

### BRIEF DESCRIPTION OF THE DRAWINGS

FIG. 1 illustrates a context of implementation of a method according to embodiments of the invention,

FIG. 2 illustrates one example of functional architecture of a client according to one embodiment of the invention,

FIG. 3 illustrates one example of human-machine interface for a client, according to embodiments of the invention.

### DETAILED DISCLOSURE OF PARTICULAR EMBODIMENTS

FIG. 1 illustrates a telecommunications network WAN for routing data streams representing audiovisual content, from a content server S to clients MOB, TV, ORD.

These contents can be typically live-streamed contents, that is to say whose determination is updated over time. In general, these contents are streamed at the time of their production.

For example, it can be television contents, such as IPTV (Internet Protocol Television), but other transmission modes can also be envisaged.

The server is accessible to clients via one or more interconnected telecommunications networks, in particular an access network allowing the clients to connect to a main WAN network (itself made up of an interconnection of sub-networks) or backbone. This WAN network is commonly called Internet.

The clients can be connected to a local area network LAN, for example a wireless local area network, allowing them to access a gateway towards the Internet access network. This wireless local area network, commonly called WLAN, can comply with the Wi-Fi protocols, or Wi-Fi, as specified in the standard documents of the IEEE 802.11 family (or ISO/IEC 8802-11).

This local area network LAN can be an internal network in a home (home network), for example allowing all the equipment or clients of a user or of a family to be connected. The local area network LAN can also be an internal network of a company, allowing the equipment or clients of the different users of the company to be connected.

A gateway P can be provided to allow the connection of the local area network LAN to the Internet network WAN.

The clients can be of different natures, a common point being to have means allowing the connection to the network. These are essentially radiocommunication components and electronic and computer components allowing the implementation of the protocol stacks required for managing the protocols associated with the network and receiving and emitting data packets.

The clients can also play audio-video contents. These can then be displayed on a screen contained or associated with the clients, or via a projector, or via speakers, for example in the case of audio-only content (radio, etc.).

The clients C1, C2 can be of different natures: computer (laptop or desktop), mobile communication terminal such as a Smartphone, digital tablet, connected television, etc.

The television can be connected natively or connected through an associated device such as a TV stick connected to the television, generally via HDMI. One example of an external device communicating with a television TV is Chromecast. Chromecast is a real-time multimedia stream player (multimedia gateway) developed and marketed by Google. The player plugs into the HDMI port of a television and communicates, via Wi-Fi connection, with another player connected to the Internet (computer, Smartphone, tablet, etc.), in order to display on the television the multimedia content received from an application compatible with Google Cast technology, from the Google Chrome browser present on a computer, or from certain Android devices.

These different clients are also intended to receive and process the content data chunks.

Particularly, they may have a software application (for example a browser) allowing access to web servers or the like, which allow making audio-video contents available to the clients' users. Thus, the various exchanges between the clients and the content servers S can be done in accordance with the protocols commonly used on the Internet, in particular the HTTP protocol.

Dynamic Adaptive Streaming over http often called DASH or MPEG-DASH or HAS (HTTP Adaptive Streaming) is a standard of format of audiovisual streaming on the Internet.

More generally, this distribution mode is typically called ABR for Adaptive Bit Rate.

This type of content is temporally segmented into a sequence of data chunks. The data chunks each correspond to a time segment.

At the same time segment, several data chunks may be available, each corresponding to a given resolution.

Thus, a function deployed on an entity connected to the WAN network (for example the content server S) consists in cutting the content, as it is produced in the case of live content, into time segments and in encoding each piece of content corresponding to this time segment into as many data chunks as there are resolutions to be made available to the different clients.

These time segments can correspond to very short durations, of the order of a few seconds (for example 2 seconds, or 10 seconds). Consequently, a content is made up of a very large number of data chunks.

The resolutions correspond to qualities of the video (and/or audio) content and consequently to different bit rates on the telecommunications network.

The qualities available in ABR may vary depending on the video streaming platform used, but in general and currently, the common qualities comprise:
Very Low Quality: Often suitable for users with very slow or unstable Internet connections, this quality can have a resolution of 240p and a bitrate of 200 kbps.
Low Quality: This quality is suitable for more stable but still relatively slow Internet connections, with a resolution of 360p and a bitrate of 400-700 kbps.
Standard Quality: This quality is suitable for most Internet connections, with a resolution of 480p or 720p and a bitrate from 800 kbps to 2 Mbps.
High Quality: This quality is suitable for fast and reliable Internet connections, with a resolution of 1,080p and a bitrate of 2-5 Mbps.
Very High Quality: This quality is suitable for very fast Internet connections, with a resolution of 4K and a bitrate of more than 10 Mbps.

It is important to note that the available qualities may vary depending on the bandwidth capabilities of the user and of the network, as well as on the quality and the complexity of the streamed video content, and on the level of performance of the encoders.

Since the data chunks correspond to very short time segments, the transmission of the content can be reactively adapted to the conditions of the telecommunications network, by switching from one resolution to another for the next time segment(s) depending on the bandwidth available on the network.

A file is provided to associate the time segments in which the content is temporally segmented with data chunk identifiers.

This file can therefore match a segment with several data chunk identifiers, when several resolutions are available. The file allows the clients to be informed of the available resolutions and to be able to select a resolution based on the perceived qualities of the display of the content during temporal segments (this quality depending in particular on the bandwidth available on the WAN and LAN networks).

This file is commonly called “manifest”.

Different formats of such “manifest” files can be used. They can for example be in XML format. The ISO/IEC 23009 standard finalized at the end of 2011 defines the format of the manifest as well as that of the data chunks based on MPEG container formats: ISO Base Media File Format (ISO/IEC 14496-12) and MPEG-2 Transport Stream (ISO/IEC 13818-1), and gives indications for the definition of other chunk formats.

The identifiers of the data chunks can also take several forms. They typically include an address, or any other “locator”, making it possible to determine how to download the identified data chunk.

Within the framework of a HAS-type implementation based on the http protocol, this identifier can be a URI (Uniform Resource Identifier). It is a short string of characters identifying a resource on a physical or abstract network, and whose syntax complies with an Internet standard set up for the World Wide Web (RFC 3986).

According to this embodiment, the clients then include means (in particular a TCP/IP protocol stack with adequate application layers) for downloading the data chunks identified by URIs by means of HTTP (HyperText Transfer Protocol) or possibly FTP (File Transfer Protocol) requests.

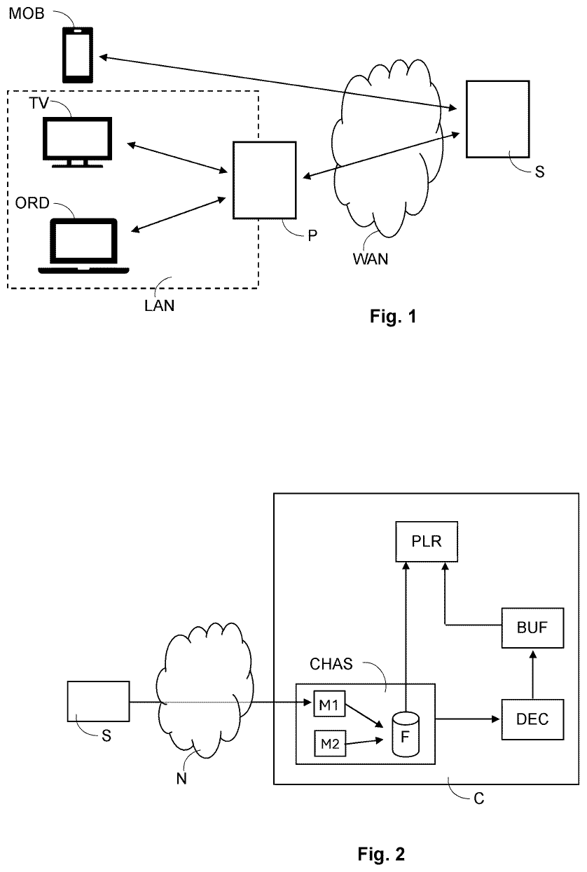

FIG. 2 illustrates one example of a functional architecture of a client according to one embodiment of a described method. A content server S and a telecommunications network N are also represented. This telecommunications network may correspond to the Internet network WAN of FIG. 1 or to an interconnection of several networks, for example of this Internet network and of a local area network LAN. Since the method described is independent of the link between the content server S and the client C, this network N will not be described in more detail.

In the illustrative example of FIG. 2, the client C includes an application client CHAS adapted for the implementation of the various mechanisms and protocols making it possible to implement the HAS mechanism.

The client CHAS (and therefore, more generally, the client C) has the means for downloading the data chunks from the content server S in order to produce them (that is to say display them in the case of multimedia content, in particular video content) on a visualization interface (screen, projector, etc.) by means of a display application, or player PLR.

The client C is therefore adapted to construct requests from the “manifest” file F, by incorporating a data chunk identifier therein, and to transmit these requests to the server S in order to trigger the downloading of the chunks identified in the requests.

The retrieved data chunks can be decoded, as they occur, by a decoder DEC and then stored in a memory BUF where they can be consumed by the display application PLR.

This mechanism being well known to those skilled in the art, and well described in the scientific and technical literature, it will not be described further in the present description.

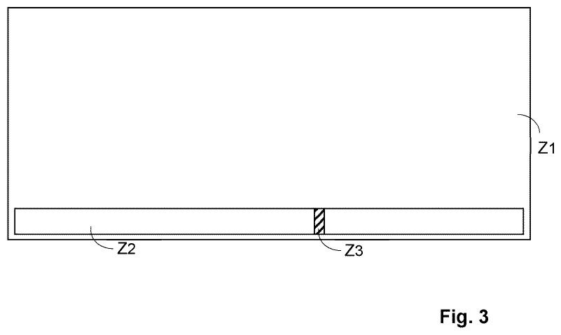

FIG. 3 illustrates one example of a human-machine interface that can correspond to a client C. The display application PLR can display the multimedia content corresponding to the data chunks decoded and consumed from the memory BUF in an area Z1 of a screen, for example.

The application PLR can also display an area Z2 representing a time axis, in which a position indicator Z3 can be represented. The position of the indicator Z3 in the time axis Z2 corresponds to the temporal position of the time segment associated with the data chunk which is being displayed, within the content.

In the case where the client displays live content in real time (that is to say without time lag), the indicator Z3 is positioned at the right end of the area Z2, corresponding to the present time.

A position further to the left corresponds to an activation of a time-shifted playback function (or start over). This function allows the user to create a display lag towards anterior time segments: he can thus view the content produced in the past. This function allows him to review some segments, to catch up on the content if he missed the beginning, etc.

The position of the indicator Z3 gives him an indication of the display lag compared to the live.

Also, the interface can be provided to allow him to move (for example by means of a remote control) the position of this indicator Z3 within the time axis Z2, in order to determine a new time lag of the display. Such a command then triggers the download of the data chunks associated with the time segments of the content corresponding to the new position of the indicator Z3.

In order to position the indicator Z3 within the time axis Z2, the display application PLR can be based on the file F.

This indeed contains all of the data chunk/time segment associations. Knowing the data chunk which is being displayed, it can therefore directly deduce its temporal position based on the identifiers present in the file F (corresponding to as many time segments) and determine the position of the indicator Z3 within the time axis Z2 which corresponds to all of the time segments available in this file F.

The method described essentially relates to the retrieval of the file F, and its construction. This construction of the file F is preferably performed so that the existing mechanisms relating to its use for the retrieval of the data chunks can be implemented without modification. Thus, one advantage achieved is not to have to modify the application PLR which can be compliant with the state of the art.

In the state of the art, the file F is retrieved regularly from the server S. Typically, this retrieval takes place in temporal synchronization with the consumption of the data chunks by the display application PLR: thus, if the data chunks correspond to 2-second segments, then the file F is retrieved every 2 seconds from the server S. In this way, the display of the indicator Z3 is correctly positioned relative to a timeline Z2 which actually corresponds to the segments available for the content on the server S, therefore to the “real time” of the live.

However, it was seen that such an embodiment can lead to numerous drawbacks, in particular related to the congestion of the link between the server S and the client C, and to the necessary processing generated by these transmissions on the server S.

According to the proposed method, the client selects an action from:
a generation of one or more data chunk identifiers (associated with a time segment), and
a transmission of a request to the server S to receive the file F.

According to one embodiment, this selection can be made based on a time interval between the current time and the segment which is being played. Other criteria can also be envisaged for the selection of an action, for example based on events on a human-machine interface of the playback device: indeed, the user's choices to move the viewing instant, the selection of a time-shifted playback mode “startover” for example, can generate the selection of an action by the client.

Thus, according to this method, the retrieval of the file F is only set up in one branch of the alternative. From then on, the file F is updated on the server S by the insertion of data chunk identifiers for each new time segment, but this file is no longer retrieved (or transmitted) to the client C.

In the other branch, instead of retrieving the file F again, it is completed locally, without exchange via the telecommunications network N.

Also, in this other branch, identifiers are deleted in order to keep a constant number of identifiers in the file F, corresponding to a time window within which the user can browse in time to create a playback lag of the content.

According to one embodiment, if the time interval makes it possible to determine whether there is time-shifted or live playback by comparing the time segment which is being displayed and a current time which can be derived from the internal clock and is representative of the production of the data chunks live on the server S (It is assumed that the clock of the client is synchronized with that of the server).

If the time interval is zero (or below a certain threshold), then this means that the display is live (or as close to live as possible). If the interval is not zero (or above this threshold), then this means that the playback (or display) is time-shifted.

The method is based on the idea that if the playback (and the display) of the data chunks is time-shifted compared to the current time, corresponding to the live, then the data chunks close to the current time are not consumed soon by the display application PLR. Also, it is considered that the retrieval of the identifiers of these chunks is not an immediate need and can be postponed in the future.

It is further noted that the content of the file F varies very gradually. If this file corresponds to 4 hours of content for example, and the time segments correspond to durations of 2 seconds, it can be easily calculated that between two productions of a data chunk, the file remains constant at 99.987% (the replacement of the oldest identifier by a new identifier representing a proportion of 0.013%).

It is therefore submitted that the transmission of this file F at each production of a new data chunk by the server S is counterproductive.

In the situation of a time-shifted playback, it is therefore proposed that the data chunks can be generated locally, by using data that are not retrieved from the server S. These data can be arbitrary.

In other words, for each segment to be inserted into the file F, corresponding to a new time segment, an arbitrary value (or more generally “not retrieved from the server S”) can be associated as a data chunk identifier.

For any insertion of one or more identifiers into the file, the same number of identifiers is deleted in order to keep the number of identifiers in the file F constant. The insertions are made at the end of the file (corresponding to the most recent time segments) and the deletions are made at the beginning of the file (corresponding to the oldest time segments).

Consequently, the number of data chunk identifiers within the file always corresponds to the number of time segments into which the content is actually segmented by the server S at the current instant. From then on, the display application PLR can rely on the information contained in the “manifest” file F to position the indicator Z3 on the timeline Z2.

The mechanism is therefore transparent from the point of view of the display application PLR in this regard.

In order to synchronize the indicator Z3 with the production of the data chunks on the server S, the generation of the identifier(s) is done by the client periodically, for a number of segments corresponding to this period (that is to say the time lapse between two generations). In other words, if the client generates chunk identifiers every x seconds, then it generates identifiers corresponding to a time interval of x seconds, in order to maintain the synchronization.

Preferably, this period corresponds to a constant duration which is that of the time segments. In other words, in this embodiment, each time a data chunk is consumed by the display application PLR, a new identifier is generated and inserted into the file F. In this way, the position of the indicator Z3 is always as close as possible to reality.

In the illustrative example of FIG. 2, the file F can thus be provided both by a conventional module M1 adapted to retrieve this file from the server S, and by a module M2 adapted to locally generate identifiers and insert them within this file F in order to update it, regularly.

The identifier generated by the client is adapted to be determined, or detected, by this same client as not corresponding to the content server S. Particularly, it can be an identifier not corresponding to the identifier field corresponding to the server. This may be an identifier whose value is known by the client so that it can be immediately detected.

It is understood that over time the client accesses the data chunk identifiers of the file F in a chronological order if the user performs a linear playback of the content.

After a certain time during this playback process, the client accesses an identifier generated by the client. Since this identifier is not provided by the content server S, it does not allow retrieving the corresponding data chunk.

The client C can however directly detect this situation, as previously indicated. According to one embodiment, when such an identifier is detected during the preparation of a request to retrieve a data chunk, the client transmits a request to receive the file F again.

This file F was updated in parallel. The receipt of the file F thus makes it possible to synchronize the information available on the client with the information available on the server S. The client can then continue by transmitting requests in data chunks based on the updated file F.

If the display application continues to operate in time-shifted playback mode, the method described will continue to generate identifiers locally, rather than retrieving the file F from the server, until the display reaches the last time segment retrieved from the server S, and the same retrieval process is then implemented.

Thus, the number of times the file F is retrieved, in the case of time-shifted playback, is drastically reduced, which makes it possible to significantly reduce the consumption and relieve the content servers, without impacting the user experience.

As seen previously, when the display is live, or close to live, the time interval between the current time and the time segment which is being played is zero or low (below a threshold). In this case, the file F can be retrieved each time a data chunk is consumed (therefore, in general, each time a data chunk is generated by the server S), in accordance with the mechanism of the state of the art.

According to the proposed method, the client selects the most appropriate action at each iteration, that is to say each time the file F must be updated. In this way, an optimum compromise is reached between minimizing the bandwidth consumption on the network N and obtaining the expected quality of service QoS for the users of the client C. The client C thus implements optimized management of the manifest files.

Of course, the present invention is not limited to the examples and to the embodiment described and represented, but is defined by the claims. It is in particular susceptible of numerous variants accessible to those skilled in the art.

Of course, the present invention is not limited to the examples and to the embodiments described and represented, but is defined by the claims. It is in particular susceptible of numerous variants accessible to those skilled in the art.

1. A method comprising:
managing access by a client to content available on at least one server through a telecommunications network, said content being temporally segmented into a sequence of data chunks, said managing comprising:
transmitting by said server a file associating time segments with data chunk identifiers, as well as an action selected among a generation by said client within said file of at least one chunk identifier associated with a time segment and a transmission of a request towards said server to receive said file again.

2. The method according to claim 1, wherein said action is selected based on a comparison of an interval between a current time and a time segment which is being displayed with a threshold.

3. The method according to claim 1, wherein said generation is performed periodically, for a number of time segments corresponding to said period.

4. The method according to claim 3, wherein said period corresponds to a constant duration of said time segments.

5. The method according to claim 1, wherein the generated identifier is adapted to be determined by said client as not corresponding to said at least one server.

6. The method according to claim 1, further including, in response to an identifier generated by the client within said file during a preparation of a request for a data chunk being detected, transmitting a request towards said server to receive said file again.

7. The method according to claim 1, wherein a position indicator is displayed to position said time segment which is being displayed based on the chunk identifiers present within said file.

8. The method according to claim 1, wherein said content is live-streamed content.

9. A client comprising:
a processor configured to carry out:
receiving a file from a content server,
associating time segments with data chunk identifiers, and
performing an action selected among a generation within said file of at least one chunk identifier associated with a time segment and a transmission of a request towards said server to receive said file again.

10. A non-transitory computer readable data storage medium on which at least one series of program code instructions has been stored for execution of the method according to claim 1.
